(19) United States
(12) Patent Application Publication
(10) Pub. No.: US 2004/0205338 A1
(43) Pub. Date: Oct. 14, 2004

(54) Method of delivering content from a source (s) to destination terminals (ti) and the associated data flow, system, destination terminal and collection server

(76) Inventor: Christian Bertin, Rennes (FR)

Correspondence Address: Thomas Langer, Cohen Pontani Liebermann & Pavane, Suite 1210, 551 Fifth Avenue, New York, NY, 10176, US

(21) Appl. No.: 10/483,799

(22) PCT Filed: Jul. 1, 2002
(86) PCT No.: PCT/FR02/02289

(30) Foreign Application Priority Data
Jul. 13, 2001 (FR) 01/09440

(51) Int. Cl. H04L 9/00; G06F 15/16

(52) U.S. Cl. 713/163; 709/231

(57) ABSTRACT

Each terminal (Ti) recovers descriptive data associated with the source (S), into which an address of a collection server (SC) is inserted. The source (S) broadcasts the content over the network, and the receiver terminals (Ti) acquire the broadcast content, using the descriptive data, and send to the address of the collection server (SC) periodic reports on the reception by said terminal (Ti) of the content broadcast by said broadcast source (S).

The present invention relates to a method of broadcasting a content in real-time from a source to a plurality of receiver terminals via a computer network, for example the Internet.

The Internet can broadcast multimedia content such as TV broadcasts, video films, conferences, and other programs, in real time to a large audience of receiver terminals. There are two main methods for broadcasting a content in real-time from one source to a plurality of receiver terminals via the Internet.

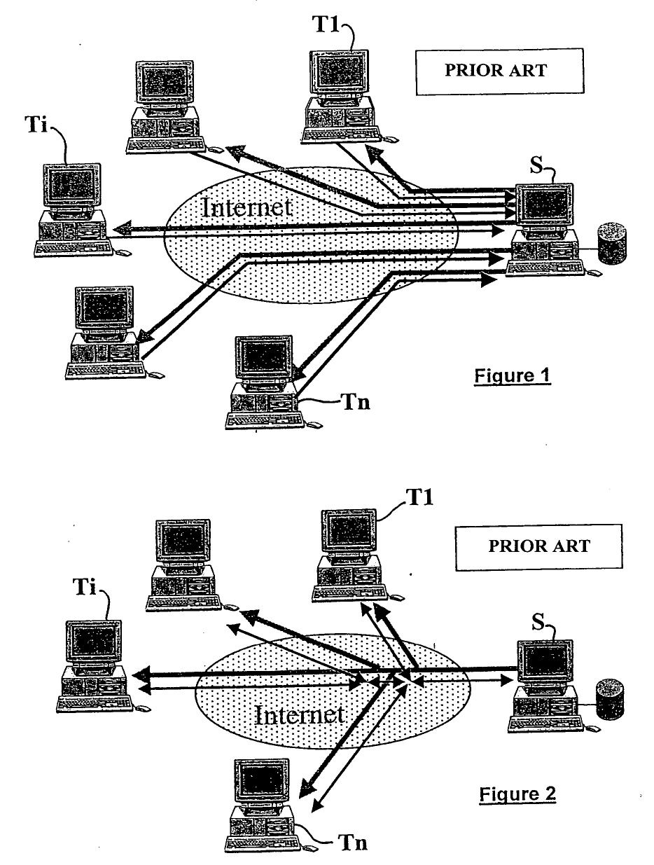

Referring to FIG. 1, the first of these methods is the “unicast” method, which consists in sending the same content as many times as there are receiver terminals T1, . . . , Ti, . . . , Tn. The source S sets up a point-to-point connection with each of the receiver terminals, divides the content to be broadcast into IP data packets, also known as “datagrams”, duplicates each IP datagram to obtain n copies, where n is the number of receiver terminals Ti, and sends the n copies to the n receiver terminals Ti, respectively.

Referring to FIG. 2, the second method is the “multicast” method and enables the source S to broadcast a multimedia content to a plurality of receiver terminals in one sending. During the broadcasting of the content, the source S sends IP datagrams that are duplicated cascade fashion by the nodes of the network, which are referred to hereinafter as “routers”, and then routed to the receiver terminals Ti. If none of the terminals Ti requests to receive the IP datagrams sent by the source, the latter are not routed beyond the first node of the network and are therefore lost. If a terminal Ti wishes to receive the multimedia content broadcast by the source S, it sends a request to acquire that content to the source S via the Internet using the Internet Group Management Protocol (IGMP). The first multicast router that receives the request and that is already receiving the IP datagrams broadcast by the source then duplicates the IP datagrams and routes them to the terminal or to another router. The expression “multicast router” refers to a node of the network which receives datagrams broadcast by the source S and routes them to at least one receiver terminal, possibly after duplicating them.

To receive a multimedia content broadcast by a source in unicast mode or in multicast mode, each receiver terminal must first recover a Session Description Protocol (SDP) descriptive file associated with the source, for example by downloading it from a website. The structure of the SDP file is defined by the Internet Engineering Task Force (IETF) in the document RFC 2327. This file is intended to convey the information required for the receiver terminals to be able to receive the multimedia content broadcast by the source. To each source there corresponds a general SDP file containing all the information required to receive from the source, regardless of the content it broadcasts. To each content that is broadcast (TV transmission, film, conference, etc.) there corresponds a specific SDP file containing all the information needed to receive that particular content. The general SDP file for the source is valid regardless of the content broadcast by the source but the SDP file for a specific content is valid only for the broadcasting of that content.

The data transmission protocol essentially used for real-time unicast or multicast broadcasting via the Internet is the Real-Time Transfer Protocol (RTP). It is usually associated with the Real-Time Transfer Control Protocol (RTCP) for controlling data streams and enabling receiver terminals to feed reception reports back to the source, which reports contain quality of service (QoS) information on reception quality, such as an indication of the bit rate at which the broadcast is received or the rate of loss of datagrams. Under the RTP, to broadcast a multimedia content, the source sends a plurality of streams conveying data corresponding to a plurality of respective media. For example, to broadcast a video film in two languages, the source sends a video stream and two audio streams, one for each language. Also, the data of the same media, for example video data or audio data, can be carried by a plurality of streams having different data bit rates. For example, to broadcast the video component of an audiovisual content, the source can send three video streams, each at 400 kbit/s, consisting of a basic video stream Vb, a first video enhancement stream Ve1 (Video enhancement 1), and a second video enhancement stream Ve2 (Video enhancement 2). Depending on their capacity, the receiver terminals use the basic video stream and where applicable add to it the video stream Ve1 and/or the video stream Ve2 to enhance video quality. Alternatively, the source can send three video streams at 400 kbit/s, 800 kbit/s and 1 200 kbit/s, respectively, the receiver terminals selecting only one of these three streams, according to their capacities. To receive a multimedia content conveyed by n streams, the receiver terminals use n pairs of communication ports each comprising an RTP port and an RTCP port to receive the n streams and to send n reception reports associated with the n streams. The RTP and RTCP communication ports associated with the same pair are in sequence, the RTP port having an even number and the RTCP port an odd number.

In the unicast mode, the source sets up as many point-to-point connections as there are receiver terminals and regularly receives reception reports containing QoS information via these point-to-point connections. Thus the source can easily be informed of any reception problems of a given terminal. However, the unicast technique is greedy in terms of bandwidth and is therefore unsuitable for broadcasting to a large audience.

In contrast, the multicast technique greatly reduces the amount of bandwidth used. However, there is no simple way to evaluate terminal reception quality because the receiver terminals are not connected directly to the source.

The RTCP can feed QoS information back to the source in unicast mode and in multicast mode, but this protocol has many drawbacks, since it is intimately related to the RTP. When the content that is broadcast is conveyed by a plurality of RTP streams, the terminals periodically send a reception report for each of the RTP streams they receive. As a result, the source receives a considerable number of reports, most of which are redundant.

The technical problem addressed by the present invention is therefore that of proposing a method of broadcasting a content from a source to a plurality of receiver terminals via a computer network and in real time, in which method each terminal recovers descriptive data associated with the source, the source broadcasts the content over the network, and the receiver terminals acquire the broadcast content, using the descriptive data, which provides a simple method of evaluating terminal reception quality.

The problem is solved in that an address of a collection server is inserted into said descriptive data and, using said descriptive data, each terminal receiving from the broadcast source sends to the address of the collection server a report on the reception by said terminal of the content broadcast by said broadcast source.

The present invention essentially addresses a multicast broadcasting problem. However, the Applicant has no intention of limiting the scope of this application to that particular example, but instead to encompass any type of broadcasting, including unicast broadcasting.

Separating the source and the report collector circumvents the drawbacks of the RTCP. The solution according to the present invention offers the additional advantage of not overloading the source with feedback of reception reports. The source is no longer burdened with processing these reports and can therefore use all of its capabilities exclusively for broadcasting. Another advantage is that the reception reports provide information on overall reception quality rather than the reception quality for a particular stream. This considerably facilitates processing the reports. Furthermore, because the address is inserted into the descriptive data associated with the source, the receiver terminal recovers it without having to take any specific action and without requiring any additional equipment.

Periodicity information is advantageously inserted into said descriptive data so that each receiver terminal can periodically send the collection server a report on the reception by the terminal of the content broadcast by said broadcast source.

Each terminal preferably inserts reception quality information into the report on the reception by the terminal of the content broadcast by said broadcast source. It can also insert therein a geographical location indication. This makes it possible to detect a reception problem linked to the infrastructure of a local network serving terminals in a given geographical area.

The collection server preferably assigns a time and a date to each report it receives on the reception by the terminal of the content broadcast by said broadcast source.

The collection server advantageously responds to reports from terminals receiving from said source, to produce a summary relating to the reception by the terminals of the content broadcast by the broadcast source. The summary can include histograms for different given times in which the bit rate at which the terminals are receiving is plotted along the abscissa axis and the number of terminals receiving from the broadcast source is plotted up the ordinate axis. The histograms constitute reception quality snapshots for the population of receiver terminals.

In one particular implementation, a plurality of sources broadcast contents to a plurality of groups of receiver terminals and all the terminals belonging to the groups send to the same collection server reports concerning the reception of the contents broadcast by their respective broadcast sources. Thus the collection server can collect reception reports from terminals belonging to different multicast groups and generate a reception summary for each multicast broadcast source.

The descriptive data can be inserted into an SDP file.

The address of the collection server can also be broadcast on a signaling channel associated with the source.

The invention also provides a collection server for implementing the method previously defined, including means for receiving reports each concerning the reception by a terminal of a content broadcast by a broadcast source and processor means adapted to respond to reports from terminals receiving from said source, to produce a summary relating to the reception by said terminals of the content broadcast by the broadcast source.

The invention further provides a receiver terminal for implementing the above-defined method, the terminal being characterized in that it is adapted to recover descriptive data associated with a broadcast source and containing an address of a collection server and to send to the address of said collection server at least one report concerning the reception of a content broadcast by the broadcast source.

The invention further provides a system for implementing the above-defined method, the system comprising:

a broadcast source adapted to broadcast a content over a network,

a collection server, and

a plurality of receiver terminals adapted to recover descriptive data associated with the broadcast source and containing an address of the collection server, to acquire the content broadcast by the broadcast source using the descriptive data, and to send to the address of the collection server a report concerning the reception of the content broadcast by the broadcast source,

said collection server being adapted to respond to reports from terminals receiving from said source, to produce a summary relating to the reception by said terminals of the content broadcast by the broadcast source.

Finally, the invention provides a descriptive data stream for implementing the above-defined method and containing information to enable a terminal to receive from a broadcast source, the data stream being characterized in that it contains information enabling a terminal to send to a collection server a report on the reception by said terminal of the content broadcast by the broadcast source.

The invention will be understood better from the following description of a particular implementation of a broadcasting method, a collection server, a receiver terminal, a system, and a data stream of the invention, which description is given with reference to the appended drawings, in which:

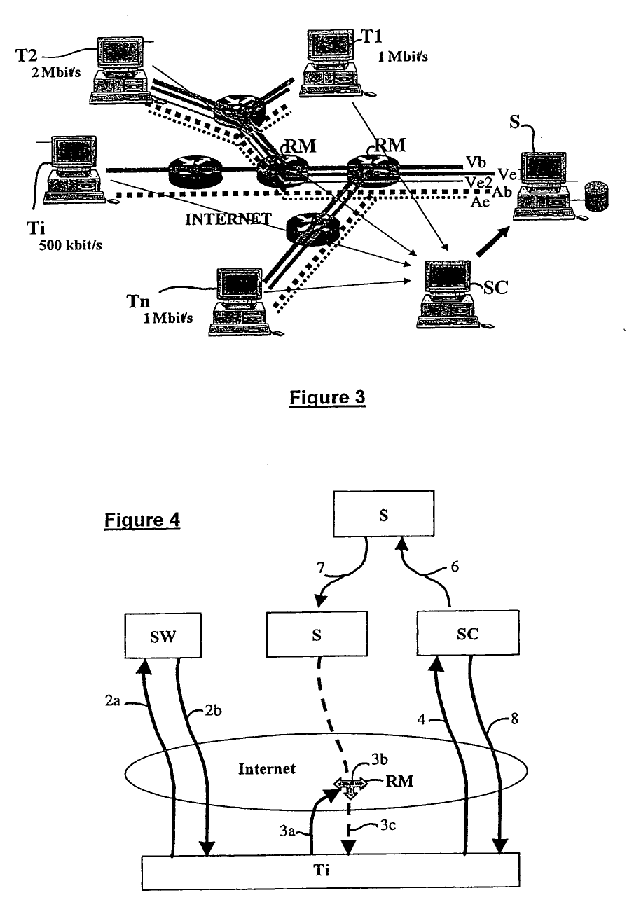

FIG. 3 is a diagram showing a plurality of receiver terminals, a broadcast source, and a collection server,

FIG. 4 is a diagram showing one of the receiver terminals, a website, the broadcast source, and the collection server, with the various steps of a specific implementation of a broadcast method of the invention,

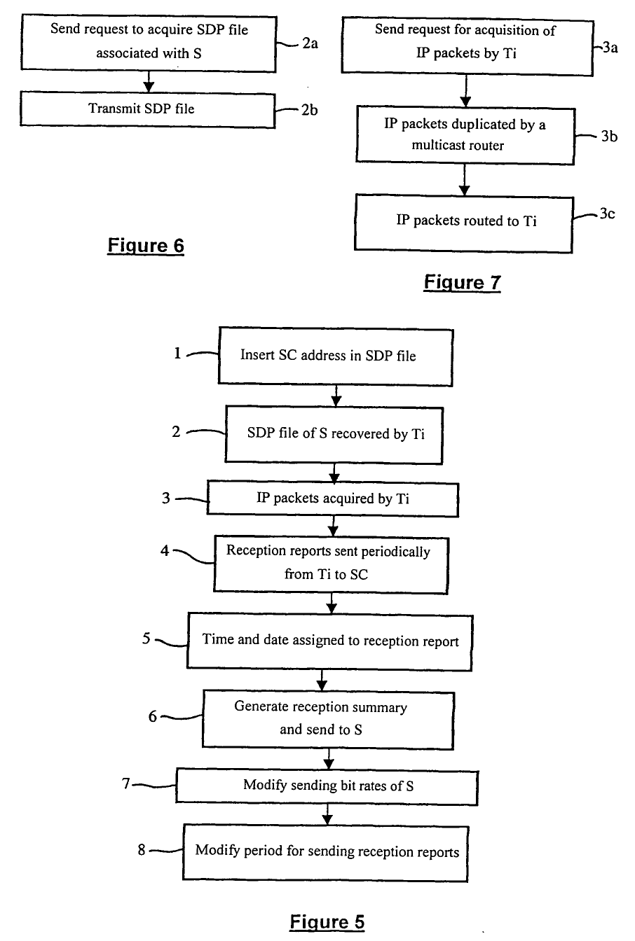

FIGS. 5 to 7 are flowcharts of the same specific implementation of a broadcast method of the invention, and

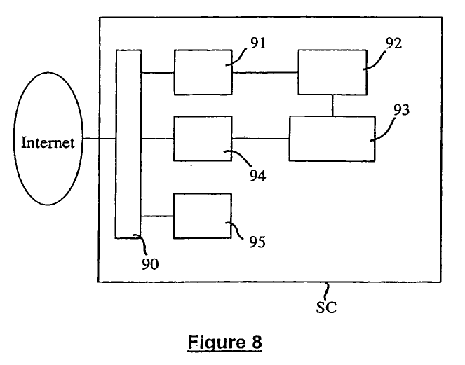

FIG. 8 is a block diagram of the FIG. 1 collection server.

FIG. 3 shows a computer network, in this instance the Internet, and a system comprising a plurality of receiver terminals, T1, T2, . . . , Ti, . . . , Tn, Internet routers RM, a content broadcast source S, and a collection server SC. The terminals T1, T2, . . . , Ti, . . . , Tn have different data reception capacities (1 Mbit/s, 2 Mbit/s, 500 kbit/s, etc.). The source S is an audiovisual broadcast channel, referred to hereinafter as “Chaine1”, hosted by an audiovisual Internet server and adapted to broadcast audiovisual content (TV transmissions, video films, etc.) to receiver terminals in multicast mode via the Internet. The audiovisual server could host other broadcast sources.

A programming center, not shown, is adapted to establish a programming chart for the broadcasting of audiovisual content by the source S and to create for the source S a general descriptive SDP file containing all the information needed for a terminal to receive from the source S and, for each broadcast content, a specific descriptive SDP file containing all the information required to receive that content. The descriptive SDP files associated with the source S are transmitted to the website SW, from which they can be downloaded by the terminals.

Note that the structure of an SDP file, as defined by the IETF, is as follows:

Session Description

v=(protocol version)

o=(owner/creator and session identifier)

s=(session name)

i=*(session information)

u=*(URL of description)

e=*(email address)

p=*(phone number)

c=*(connection information—not required if included in all media)

b=*(bandwidth information)

One or more time descriptions (see below)

z=*(time zone adjustments)

k=*(encryption key)

a=*(zero or more session attribute lines)

Zero or more media descriptions (see below)

Time Description

t=(time the session is active)

r=*(zero or more repeat lines)

Media Description

m=*(media name and transport address)

i=*(media title)

c=*(connection information—optional if included at session level)

b=*(bandwidth information)

k=*(encryption key)

a=*(zero or more attribute lines)

The fields marked “*” are optional.

For more information on the structure of SDP data, see the IETF document RFC 2327.

The collection server SC, which is connected to the Internet, collects reports on reception by the receiver terminals Ti of the content broadcast by the broadcast source S. It includes an Internet interface 90, a report receiver unit 91, a unit 92 for timing and dating reception reports, a processor unit 93, a unit 94 for sending the summary to the source S, and a unit 95 for modifying the period for sending reception reports from receiver terminals Ti. All these units are connected to a central control unit, not shown, for controlling the operation of the server SC. The units 91, 94 and 95 are connected to the connection interface 90. The time and date unit 92 between the receiver unit 91 and the processor unit 93 times and dates the reception reports received. The processor unit 93, which is connected to the sender unit 94, responds to reception reports coming from the terminals Ti receiving from the broadcast source S by producing a statistical summary concerning reception by the terminals Ti of the content broadcast by the broadcast source S.

Each receiver terminal Ti includes an Internet connection module, an Internet browser, a multicast receiver module, a man-machine interface, and a central control unit to which all the units of the terminal Ti are connected and which controls their operation. The man-machine interface includes a display screen, an input device, consisting in this example of a keypad and a mouse, and a loudspeaker. The multicast receiver module is adapted to receive reports on the reception by the terminal Ti of the content broadcast by the source S from a broadcast source S via the Internet and to send them to the collection server SC, in this example periodically. In use, to receive from a broadcast source S via the Internet, the receiver module cooperates with the Internet connection module and the Internet browser to recover a stream of descriptive data associated with the broadcast source S, and here carrying an SDP file, by downloading it from the website SW. Using information contained in the SDP file, the receiver module receives from the source S, i.e. acquires the content broadcast thereby, and in parallel with this periodically sends to the address of the collection server SC, extracted from the SDP file, reports on the reception by the terminal Ti of the content broadcast by the source S.

The method of broadcasting an audiovisual content in real time from the source S to a plurality of terminals Ti via the Internet in multicast mode is described next with reference to FIGS. 4 to 7. In the specific example described here, the content broadcast is a video film entitled “La Grande Vadrouille”.

In a step 1, the programming center inserts a field “q” associated with the collection server SC into the specific SDP file of the content to be broadcast, namely the film “La Grande Vadrouille”, and into the general SDP file of the source S. The field “q”, which is defined below, contains all the information required for a receiver terminal Ti to send a reception report periodically to the collection server SC.

Field q

q=<network type><address type><connection address><port><time period>

The field “q”, which really constitutes a command to send reception reports to the server SC, contains an indication of the network to which the server SC belongs, the server SC address type, the server SC address, the server SC communication port number, and the period τ for sending reception reports to the server SC.

The SDP file of the source and the SDP file of the film are transmitted to the website SW and can be downloaded from that site by the terminals. The SDP file of the film contains the following information, for example:

v=0

o=channell IN IP4 126.16.64.4

s=La grande vadrouille

u=http://www.chainel.fr/films/la_grande_vadrouille.htm

e=infos@chaine1.fr

c=IN IP4 224.2.17.12/127

t=2873397496 2873404696

a=recvonly

m=audio 49170 RTP/AVP 0

m=video 51372 RTP/AVP 31

m=application 32416 udp wb

q=IN IP4 224.2.1.1 32416 300

The field “q” indicates that:

the server SC is an Internet server;

the address of the server SC is an IP4 address;

the IP address of the server SC is 224.2.1.1;

the communication port number of the server SC is 32416, and

the period τ for sending reception reports is 300 seconds.

In a step 2, each terminal Ti wishing to receive the film recovers a stream of descriptive data associated with the broadcast source S and carrying either the specific SDP file for the required film or the general SDP file for the source S. Remember that the SDP file for the film is valid only for the broadcasting of the film concerned, whereas the SDP file for the source enables reception from the source at any time, regardless of the content it is broadcasting. To recover one of these two SDP files, in a step 2a, the terminal logs onto to the website SW and sends it a request to acquire the SDP file in question. On receiving that request, in a step 2b, the website SW sends the stream of descriptive data conveying the required file to the terminal Ti, which stores it.

The source S broadcasts the video film in multicast mode via the Internet. To do this, it sends IP data packets carrying the audiovisual content to a plurality of receiver terminals once and for all, via the Internet. In this example the audiovisual data is conveyed by three video streams, each at 400 kbit/s, consisting of a basic video stream Vb, a first video enhancement stream Ve1, and a second video enhancement stream Ve2, and two audio streams, each at 400 kbit/s, comprising a basic audio stream Ab and an audio enhancement stream Ae. Depending on their capabilities, the receiving terminals Ti use the basic video and audio streams Vb and Ab and where applicable add thereto at least one of the video enhancement streams Ve1, Ve2 and/or the audio enhancement stream Ae, to enhance video and/or audio quality.

In a step 3, from information contained in the SDP file received, each terminal Ti wishing to receive the film acquires the IP data packets broadcast by the source S over the Internet. Step 3 comprises a number of substeps:

the terminal Ti sends a request to acquire the audiovisual content broadcast by the source S, namely the video film “La Grande Vadrouille”, to the source S, via the Internet, using the IGMP (step 3a),

the first multicast router RM that receives the request duplicates the IP packets received from the source (step 3b), and

the router RM routes the duplicated IP packets to the terminal Ti via the Internet (step 3c).

Remember that, by definition, a “multicast router” is a node of the network that receives IP data packets broadcast by the source S and routes them to one or more terminals, where applicable after duplicating them, if necessary.

In a step 4, on receiving the first IP data packet broadcast by the source S, the terminal Ti sends the collection server SC a report concerning the reception of the content broadcast by the source S via the Internet. This first reception report informs the collection server SC that the terminal Ti has just begun to receive from the source S. It contains information on reception quality, namely the bit rate at which the terminal Ti is receiving and the rate of loss of IP packets, together with a geographical indication of the location of the terminal Ti. The terminal Ti repeats step 4 periodically, at a frequency 1/τ, until it interrupts the reception of IP packets broadcast by the source S. Before interrupting reception, if it has the capability to do so, the terminal Ti sends a last reception report specifying that it is about to cease receiving.

The collection server SC receives the reports from all the terminals Ti of the multicast group associated with the source S, i.e. the terminals Ti receiving from the source S, and assigns a time and a date to each report received (step 5). The expression “multicast group” refers to all the terminals receiving from the same multicast broadcast source S.

In a step 6, based on the reception reports it has received, the collection server SC generates a statistical summary concerning the reception of the content broadcast by the source S by the terminal Ti receiving from the source S. This reception summary relating to the broadcast source S contains respective histograms concerning the bit rate at which the IP packets are received by the receiver terminals Ti, the rate of loss of IP packets by the receiver terminals Ti, and the location of the receiver terminals Ti. For example, the histogram relating to the reception bit rate at a given time shows along the abscissa axis various bit rates at which IP packets are received by the terminals Ti and up the ordinate axis the number of terminals receiving from the broadcast source S for each of those bit rates. The collection server SC then transmits the reception summary to the source S directly or indirectly.

In a step 7, by taking account of the summary concerning reception of one or more contents broadcast by the broadcast source S, the latter can modify the bit rates of the audio and/or video streams being broadcast in order to adapt them to the actual reception conditions. For example, if a large number of terminals are not receiving the basic video and audio streams Vb and Ab at 400 kbit/s with sufficient quality, the source can create new basic streams at 200 kbit/s.

In a step 8, to reduce the number of reports received, the server SC transmits to the terminals Ti a command to modify the period for sending reception reports, indicating a new period τ′ greater than the period τ. On receiving this command, each terminal Ti replaces the old period τ in its memory with the new period τ′. In the same way, the server SC could reduce the period for sending reception reports, in order to receive more reports.

The collection server SC can be used by a plurality of broadcast sources S. In this case, because the broadcast sources S broadcast audiovisual contents to various multicast groups of receiver terminals, all the receiver terminals belonging to the various multicast groups send reception reports to the same collection server SC. The latter then produces different individualized reception summaries concerning the respective different broadcast sources. In other words, for each broadcast source S, the collection server SC produces a reception report relating to the broadcast source S and transmits the summary to the broadcast source S.

In the foregoing description, the descriptive data associated with the source S is inserted into an SDP file and the receiver terminals Ti recover the SDP file by downloading it from a website SW. The terminals could recover the descriptive data associated with the source by any other means. For example, the descriptive data could be inserted into an electronic mail sent to the terminal Ti.

In a different implementation of the invention, the characteristics of the collection server are broadcast on a signaling channel associated with the source. In this case, if a terminal wishes to receive the content broadcast by the broadcast source, it first recovers the information needed to receive the signaling channel associated with the source, for example by downloading it from a website, and then receives the signaling channel in order to acquire the descriptive data associated with the source, containing information needed to receive from the source, as well as the characteristics of the collection server contained in the field “q” previously described.

The descriptive data associated with a broadcast source, containing all the information required to received from that source, could be contained in a file with a format other than the SDP format, for example an XML format file.

The invention can be applied to the broadcasting in real time of any type of content via a computer network other than the Internet. It can also be applied to unicast broadcasting.

1. A method of broadcasting a content from a source (S) to a plurality of receiver terminals (Ti) via a computer network and in real time, in which method each terminal (Ti) recovers descriptive data associated with the source (S), the source (S) broadcasts the content over the network, and the receiver terminals (Ti) acquire the broadcast content, using the descriptive data, which method is characterized in that an address of a collection server (SC) is inserted into said descriptive data and, using said descriptive data, each terminal (Ti) receiving from the broadcast source (S) sends to the address of the collection server (SC) a report on the reception by said terminal (Ti) of the content broadcast by said broadcast source (S).

2. A method according to claim 1, wherein periodicity information is inserted into said descriptive data so that each receiver terminal (Ti) can periodically send the collection server (SC) a report on the reception by the terminal (Ti) of the content broadcast by said broadcast source (S).

3. A method according to claim 1, wherein each terminal (Ti) inserts reception quality information into the report on the reception by the terminal (Ti) of the content broadcast by said broadcast source (S).

4. A method according to claim 1, wherein each terminal (Ti) inserts a geographical location indication into the report on the reception by the terminal (Ti) of the content broadcast by said broadcast source (S).

5. A method according to claim 1, wherein the collection server (SC) assigns a time and a date to each report it receives on the reception by the terminal (Ti) of the content broadcast by said broadcast source (S).

6. A method according to claim 1, wherein the collection server (SC) responds to reports from terminals (Ti) receiving from said source (S), to produce a summary relating to the reception by the terminals (Ti) of the content broadcast by the broadcast source (S).

7. A method according to claim 1, wherein a plurality of sources broadcast contents to a plurality of groups of receiver terminals (Ti) and all the terminals belonging to the groups send to the same collection server (SC) reports concerning the reception of the contents broadcast by their respective broadcast sources (S).

8. A method according to claim 1, wherein an indication of the network of the collection server (SC) and/or the collection server (SC) address type and/or a reception report receiver port indication is/are also inserted into said descriptive.

9. A method according to claim 1, wherein the collection server (SC) transmits new periodicity information to the receiver terminals (Ti) to modify the period for sending reports.

10. A method according to claim 1, wherein the descriptive data is inserted into an SDP file.

11. A method according to claim 1, wherein the address of the collection server is broadcast on a signaling channel associated with the source.

12. A collection server for implementing the method according to claim 1, including means (91) for receiving reports each concerning the reception by a terminal (Ti) of a content broadcast by a broadcast source (S), and processor means (93) adapted to respond to reports from terminals (Ti) receiving from said source (S), to produce a summary relating to the reception by said terminals (Ti) of the content broadcast by the broadcast source (S).

13. A server according to claim 12, including means (92) for dating and timing reports from receiver terminals (Ti).

14. A server according to claim 12, including means (95) for modifying the period for sending reception reports.

15. A receiver terminal for implementing a method according to claim 1, characterized in that it is adapted to recover descriptive data associated with a broadcast source (S) and containing an address of a collection server (S) and to send to the address of said collection server (SC) at least one report concerning the reception of a content broadcast by the broadcast source (S).

16. A terminal according to claim 15, characterized in that it is adapted to send periodically to the address of the collection server (SC) reports concerning the reception of a content broadcast by the broadcast source (S).

17. A system for implementing the method according to claim 1, the system comprising:
a broadcast source (S) adapted to broadcast a content over a network,
a collection server (SC), and
a plurality of receiver terminals (Ti) adapted to recover descriptive data associated with the broadcast source (S) and containing an address of the collection server (SC), to acquire the content broadcast by the broadcast source (S) using the descriptive data, and to send to the address of the collection server (SC) a report concerning the reception of the content broadcast by the broadcast source (S),
said collection server (SC) being adapted to respond to reports from terminals (Ti) receiving from said source (S), to produce a summary relating to the reception by said terminals (Ti) of the content broadcast by the broadcast source (S).

18. A system according to claim 17, wherein the receiver terminals (Ti) are adapted to send reception reports periodically to the collection server (SC) and said collection server (SC) includes means (95) for modifying the period for sending reception reports.

19. A descriptive data stream for implementing the method according to claim 1 and containing information to enable a terminal (Ti) to receive from a broadcast source (S), characterized in that it contains information enabling the terminal (Ti) to send to a collection server (SC) a report on the reception by said terminal (Ti) of the content broadcast by the broadcast source (S).

20. A data stream according to claim 19, characterized in that it contains a network address of the collection server (SC).

21. A data stream according to claim 20, characterized in that it also contains an indication of the network to which the collection server (SC) belongs and/or the collection server (SC) address type and/or the number of a communication port of the collection server (SC) and/or a period for sending reception reports to the collection server (SC).

22. A data stream according to claim 19, wherein the descriptive data is to the SDP format.
